(19) United States
(12) Patent Application Publication
(10) Pub. No.: US 2019/0003875 A1
(43) Pub. Date: Jan. 3, 2019

(54) METHOD FOR REYNOLDS NUMBER CORRECTION OF A FLOW MEASUREMENT OF A CORIOLIS FLOW MEASURING DEVICE

(71) Applicant: Endress + Hauser Flowtec AG, Reinach (CH)

(72) Inventors: Stephan Natter, Steinen (DE); Ton Leenhoven, Flayosc (FR); Paul Ceglia, Bottmingen (CH); Martin Josef Anklin, Dornach (CH)

(21) Appl. No.: 16/061,812

(22) PCT Filed: Nov. 15, 2016
(86) PCT No.: PCT/EP2016/077748

§ 371 Date: Jun. 13, 2018

(30) Foreign Application Priority Data
Dec. 18, 2015 (DE) 10 2015 122 225.6

(51) Int. Cl. G01F 25/00; G01F 1/84; G01F 15/02

(52) U.S. Cl. CPC G01F 25/0015; G01F 15/022; G01F 1/8436

(57) ABSTRACT

A method for ascertaining a Reynolds number compensated flow velocity and/or a Reynolds number compensated flow (G) by a Coriolis flow measuring device, comprising steps as follows: a. ascertaining at least one meter factor (C) during a calibration time interval in a calibration plant (a) based on measured values (A and B) of the Coriolis flow measuring device and a piston test apparatus of the calibration plant (a) by an evaluation unit of the calibration plant (a); b. transmitting the meter factor (C) from the evaluation unit of the calibration plant (a) to an evaluation unit of the Coriolis-flow measuring device; c. associating a Reynolds number (H) with this meter factor (D) while the Coriolis flow measuring device is connected to the calibration plant (a), and storing at least one data set of at least one number pair (D), in each case, of a Reynolds number and a meter factor, in the Coriolis flow measuring device; d. ascertaining an uncorrected measured value (E) for a flow velocity and/or a flow of a measured medium (M) at a measuring point (b), the density of the measured medium (M) at the measuring point (b) and the viscosity of the measured medium at the measuring point (b); e. ascertaining a Reynolds number based on the measured value (E) of the flow velocity and/or flow, the density and the viscosity of the measured medium (M) determined in step d) and associating a meter factor (C) with this Reynolds number; and f. correcting the uncorrected measured value (E) of flow velocity and/or flow based on the associated meter factor (C) and outputting the Reynolds number-corrected flow velocity and/or the Reynolds number-corrected flow (G), and a Coriolis flow measuring device.

The present invention relates to a method of flow measurement based on a Coriolis flow measuring device having a Reynolds number correction, as such method is defined in the preamble of claim 1.

It is known to test flow measuring devices in a calibration plant by means of a piston test apparatus, a so-called piston prover, in order, thus, to test, whether the devices output the exact measured value under application conditions.

In many cases, however, a user of the flow measuring device states for a customer a volume flow, i.e. volume flow rate or total volume flow, which is standardized to 15° C. and standard pressure. This value is the basis for billing the amount of fluid, e.g. in the form of petroleum or other products, delivered to the customer.

Starting from the aforementioned facts, it is an object of the present invention to perform a compensation of a flow or a flow velocity ascertained at a measuring point as a function of an ascertained Reynolds number.

The present invention achieves this object by a method as defined in claim 1.

A method of the invention for ascertaining a Reynolds number compensated flow velocity and/or a Reynolds number compensated flow by a Coriolis flow measuring device includes at least steps as follows:

step a: ascertaining at least one meter factor during a calibration time interval in a calibration plant based on measured values of the Coriolis flow measuring device and a piston test apparatus of the calibration plant by an evaluation unit of the calibration plant;

The aforementioned ascertaining can occur by comparing the measured values of the Coriolis flow measuring device and the piston test apparatus. Alternatively or supplementally to the comparison, of course, a large number of other mathematical operations can be performed. The meter factor is a technical term, which is regularly utilized and correspondingly defined, for example, by the API (American Petroleum Institute) and other institutes.

step b: following the ascertaining, the aforementioned meter factor is transmitted from the evaluation unit of the calibration plant to an evaluation unit of the Coriolis flow measuring device. This transmission is also referred to by those skilled in the art in such a manner that the meter factor is written back from the calibration plant into the Coriolis flow measuring device.

step c: in the Coriolis flow measuring device, a Reynolds number is associated with this meter factor and at least one data set containing a number pair composed of a Reynolds number and an associated meter factor is stored in the Coriolis flow measuring device. The Reynolds number can be ascertained e.g. by measuring the density and the viscosity by the Coriolis device or by one or more additional sensors. It can, however, also be that the Reynolds number is known, to the extent that the calibration medium, which is led through the calibration plant, is known.

step d: the Coriolis flow measuring device can additionally ascertain an uncorrected measured value E for a flow velocity and/or a flow of a measured medium at a measuring point.

step e: the Coriolis flow measuring device ascertains the density of the measured medium at the measuring point and the viscosity of the measured medium at the measuring point. From the uncorrected measured value, the density and the viscosity, a Reynolds number is ascertained. For this Reynolds number, a meter factor is ascertained based on the one or more stored number pairs.

step f: finally a correcting the uncorrected measured value of flow velocity and/or flow is performed based on the associated meter factor and a Reynolds number-corrected flow velocity and/or a Reynolds number-corrected flow is output.

By creating, storing and associating one or more Reynolds number—meter factor number pairs, the Reynolds number dependence of the meter factor can be taken into consideration in the measuring.

The aforementioned steps do not absolutely need to be performed in the sequence set forth here.

Advantageous embodiments of the invention are subject matter of the dependent claims.

Advantageously, a plurality of meter factors are ascertained as in step a) at different flow velocities or flows and a plurality of number pairs of a Reynolds number and a meter factor are created and stored in the evaluation unit of the Coriolis flow measuring device. Advantageously, a number of number pairs are utilized, in order to associate a meter factor with a flow, e.g. a volume flow rate, and/or a flow velocity at ascertained Reynolds number.

It is additionally advantageous that the data set includes at least 20 number pairs, in each case, of a Reynolds number and a meter factor. In this way, advantageously, a very exact associating of meter factors with Reynolds number can occur.

The Reynolds number in step c) can be ascertained based on the Coriolis flow measuring device by its ascertaining a flow velocity and/or a flow and a density and a viscosity of a calibration medium during the calibration interval.

The transmitting of the meter factor as in step b) from the calibration plant to the Coriolis flow measuring device can advantageously occur through a serial interface, especially via a ModBus protocol.

Further according to the invention, the Coriolis flow measuring device has an evaluation unit, wherein the evaluation unit especially has a memory unit, in which evaluation unit, or memory unit, at least one data set of number pairs, in each case, of a meter factor and an associated Reynolds number, is stored and wherein the evaluation unit is equipped to correct an uncorrected flow velocity and/or an uncorrected flow by ascertaining the Reynolds number e.g. at a measuring point and by associating the relevant meter factor of the data set.

Usually, an evaluation unit includes at least one memory unit and one computing unit.

Advantageously additionally stored in the evaluation unit, especially in the memory unit, are one or more correction factors and/or one or more correction algorithms for the case in which the Reynolds number ascertained at the measuring point does not correspond to a Reynolds number, which is stored with a meter factor as a number pair. In this way, a meter factor can still be determined, for example, by interpolation with the number pairs neighboring or nearest the ascertained Reynolds number.

The invention will now be explained in greater detail with the aid of the appended drawing, the sole FIGURE of which shows as follows:

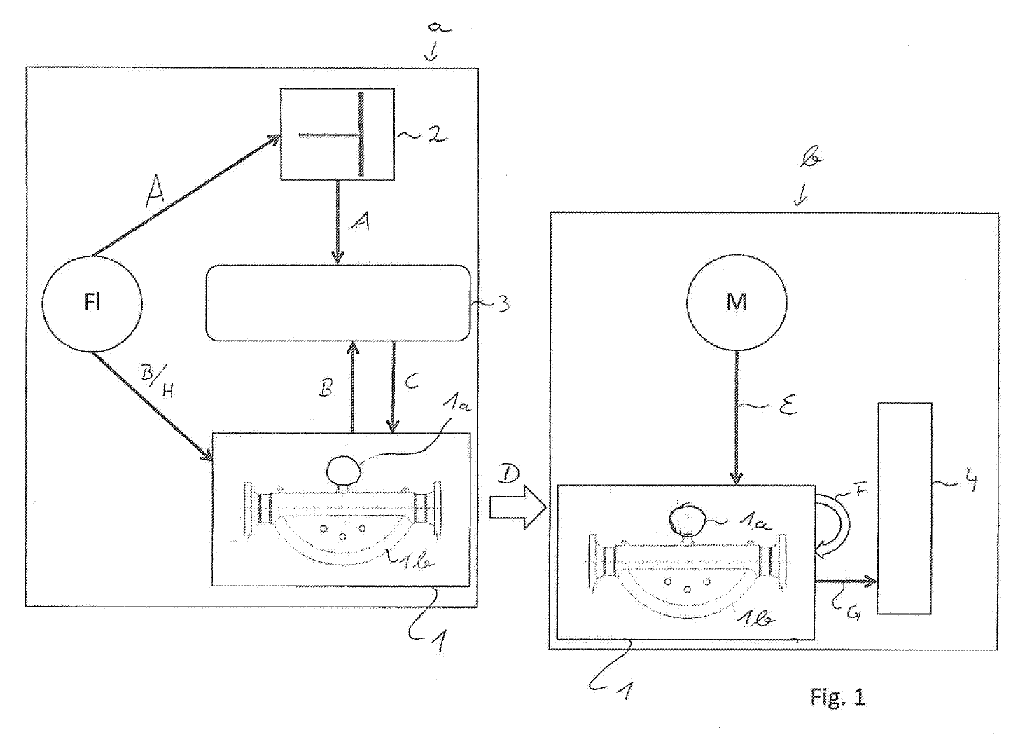

FIG. 1 schematic representation of a method for Reynolds number-compensated flow measurement.

A goal of the method is calibration of a Coriolis flow measuring device based on a prover, thus a highly accurate, volumetric measuring instrument.

The measuring principle of a Coriolis flow measuring device will be summarized based on a two tube Coriolis flow measuring device. There are, however, e.g. also single tube- or 4-tube Coriolis flow measuring devices, which likewise fall within the scope of the present invention.

The measuring principle is based on the controlled production of Coriolis forces. These forces occur in a system when simultaneously translational (straight line) and rotary (rotating) movements superimpose. The size of the Coriolis force depends on the moved mass, its velocity in the system and, thus, on the mass flow. Instead of a constant rotational velocity, an oscillation occurs in the measuring transducer.

In the case of the measuring transducer, two measuring tubes flowed through with parallel flow by the measured material are caused to oscillate with opposite phase and act similarly to the two tines of a tuning fork. The Coriolis forces produced in the measuring tubes introduce a phase shift in the tube oscillation. In the case of zero flow, thus in the case of stoppage of the measured material, the two tubes oscillate in phase. In the case of mass flow, the tube oscillation is retarded on the inlet side and accelerated on the outlet side.

The greater the mass flow, the greater also is the phase difference between the two oscillating measuring tubes. Electrodynamic sensors are used to sense the tube oscillation on the inlet side and on the outlet side. System balance is achieved by the opposing oscillations of the two measuring tubes. The measuring principle works basically independently of temperature, pressure, viscosity, conductivity and flow profile.

In addition to the mass flow, also a density measurement of the measured medium is possible. In such case, the measuring tube is excited to its resonant frequency. As soon as the mass, and, thus, the density, of the oscillating system, thus of the measuring tube and the measured substance, changes, then the exciter frequency is readjusted. The resonant frequency is, thus, a function of the density of the measured material. Due to this dependence, a density signal can be won, e.g. by means of a microprocessor.

From the mass flow and the density, additionally a volume flow can be ascertained.

For computer compensation of temperature effects, the temperature of the measuring tube can be registered. This signal corresponds to the process temperature and is also available as an output signal.

With an additional qualification of a Coriolis flow measuring device at a calibration plant at different Reynolds numbers, Coriolis flow measuring devices can be individually tuned. This will be explained in greater detail below.

First, a Coriolis measuring device 1 to be corrected is installed in a calibration plant a. The calibration plant a has a piston test apparatus 2, a so-called piston prover. This can volumetrically highly accurately determine measured values at a first flow rate A for a flowable medium in the form of fluid F1, which is led through the flow measuring device and through the calibration plant. The measured values of a second flow rate B can also be determined by means of the Coriolis flow measuring device. By comparing the prover-measured values with the measured values of the Coriolis flow measuring device connected to the calibration plant, a so called meter factor C can be determined, such as it is defined e.g. by the API (American Petroleum Institute) in its guidelines MPMS Chapter 12 “Calculation of Petroleum Quantities”.

This meter factor C can be determined e.g. by an evaluation unit 3 of the calibration plant, which is often also called the flow computer. This evaluation unit can ascertain the meter factor C by comparing the measured values A and B or variables of the Coriolis flow measuring device 1 and the prover 2 derived therefrom.

The Reynolds number cannot be compensated in usual calibration plants, since an ascertaining and compensation of the Reynolds number is most often not provided in a calibration plant.

The meter factor is then transmitted from the evaluation unit 3 of the calibration plant a into an evaluation unit 1a of the Coriolis flow measuring device 1. Usually, a Coriolis flow measuring device is composed, as in the case of most other flow measuring devices, of a measurement transmitter and a measuring transducer 1b. In such case, the measuring transducer 1b serves for registering measurement signals and the measurement transmitter converts these into output values understandable to the user. The evaluation unit 1a of the Coriolis flow measuring device, is, thus, the measurement transmitter.

This can occur preferably using a serial interface and a communication protocol, e.g. a communication protocol usual in the oil and gas industry. The transmission can especially occur via the communication protocol, ModBus.

In the Coriolis flow measuring device, a Reynolds number H for the given meter factor C is stored for the calibration point in time or the calibration interval.

$$Re = \frac{ρ \cdot υ \cdot d}{η}$$

The Reynolds number depends, thus, on the ascertained density, viscosity and flow velocity in the case of constant cross section of the one or more tubes of the flow measuring device. This Reynolds number H is ascertained at the calibration plant by the Coriolis flow measuring device 1 and stored together with the meter factor C as a number pair D of a data set in the evaluation unit 1a of the Coriolis flow measuring device, especially a memory unit of the evaluation unit 1a.

The calibration point in time or the calibration interval can be determined, for example, by means of a drag pointer or a history matrix stored in the Coriolis flow measuring device in a memory unit of the evaluation unit of the Coriolis flow measuring device.

An adaptive correction is determined for the measured error and captured. The piston test apparatus detects an error and a meter factor is associated with it, in order to cancel the error.

The measured error is an ascertained error of the Coriolis flow measuring device during operation of the flow measuring device.

The adaptive correction occurs by an interpolation of the meter factors stored in the Coriolis flow measuring device and which were determined previously by the piston test apparatus during the calibration procedure.

Now, a concrete process flow will be briefly described.

The flow measuring device is so set up in the plant that it can automatically determine a Reynolds number based on an ascertained viscosity, density and flow velocity.

This Reynolds number can then be checked, e.g. by on-site calibration. In such case, for each Reynolds number a meter factor can be determined, which then enables correcting a mass flow under conditions at the location of use.

The meter factor and the stored Reynolds number for this meter factor can be stored as a numerical value pair in the evaluation unit of the Coriolis flow measuring device.

Thus, a number pair D composed of the meter factor and the Reynolds number can be created.

If the Coriolis flow measuring device 1 is then removed from the calibration plant a, a meter factor C can be obtained for an ascertained Reynolds number of a measured medium M at the measuring point b, i.e. at the location of use, and the ascertained mass flow or the ascertained flow velocity compensated via this meter factor C and a corrected mass flow or a corrected flow velocity ascertained.

To the extent that the Reynolds number ascertained by the Coriolis flow measuring device at the measuring point does not correspond to a Reynolds number, meter factor, number pair D, an interpolation F is performed between the two straddling, stored, number pairs D.

Finally, then a Reynolds compensated, measured value for a flow, e.g. a volume flow rate, and/or a flow velocity G can be transmitted to an output unit 4. The evaluation unit in FIG. 1 is spaced from the Coriolis flow measuring device 1. It can, however, also be integrated in the Coriolis flow measuring device 1, especially in the evaluation unit 1a.

On the whole, thus, an improved measuring performance can be achieved by an adaptive Reynolds number correcting of the meter factor. In this way, measuring devices can be qualified by predetermination of a correction factor or correlation algorithm between meter factor(s) and Reynolds number(s) in the calibration plant and individually tuned under measuring conditions.

### LIST OF REFERENCE CHARACTERS

1 Coriolis flow measuring device
2 piston test apparatus
3 evaluation unit of the calibration plant
4 output unit
A measured value of flow velocity and/or flow
B measured value of flow velocity and/or flow
C meter factor
D data set with number pairs—Reynolds number/meter factor
E uncorrected measured values
F interpolation
G corrected flow velocity and/or corrected flow
H Reynolds number
M measured medium
F1 fluid in the calibration plant
a calibration plant
b measuring point

1-9. (canceled)

10. A method for ascertaining a Reynolds number compensated flow velocity and/or a Reynolds number compensated flow (G) by a Coriolis flow measuring device, comprising the steps as follows:
a. ascertaining at least one meter factor (C) during a calibration time interval in a calibration plant (a) based on measured values (A and B) of the Coriolis flow measuring device and a piston test apparatus of the calibration plant (a) by an evaluation unit of the calibration plant (a);
b. transmitting the meter factor (C) from the evaluation unit of the calibration plant (a) to an evaluation unit of the Coriolis-flow measuring device;
c. associating a Reynolds number (H) with this meter factor (D) while the Coriolis flow measuring device is connected to the calibration plant (a), and storing at least one data set of at least one number pair (D), in each case, of a Reynolds number and a meter factor, in the Coriolis flow measuring device;
d. ascertaining an uncorrected measured value (E) for a flow velocity and/or a flow of a measured medium (M) at a measuring point (b), the density of the measured medium (M) at the measuring point (b) and the viscosity of the measured medium at the measuring point (b);
e. ascertaining a Reynolds number based on the measured value (E) of the flow velocity and/or flow, the density and the viscosity of the measured medium (M) determined in step d) and associating a meter factor (C) with this Reynolds number; and
f. correcting the uncorrected measured value (E) of flow velocity and/or flow based on the associated meter factor (C) and outputting a Reynolds number-corrected flow velocity and/or Reynolds number-corrected flow (G).

11. The method as claimed in claim 10, wherein:
a plurality of meter factors (C) are ascertained as in step a) at different flow velocities or flows and a number of number pairs (D), in each case, of a Reynolds number (H) and a meter factor (C), are created and stored in the evaluation unit (1a).

12. The method as claimed in claim 10, wherein:
the data set includes at least 20 number pairs (D), in each case, of a Reynolds number and a meter factor.

13. The method as claimed in claim 10, wherein:
the Reynolds number (H) in step c) is ascertained based on the Coriolis flow measuring device by its ascertaining a flow velocity and/or a flow and a density and a viscosity of a calibration medium during the calibration interval.

14. The method as claimed in claim 10, wherein:
in step d) a meter factor for an ascertained Reynolds number is obtained by interpolation with meter factors (C) of neighboring Reynolds numbers (H).

15. The method as claimed in claim 10, wherein:
the transmitting of the meter factor (C) as in step b) from the evaluation unit of the calibration plant to the Coriolis flow measuring device occurs by a serial interface.

16. The method as claimed in claim 14, wherein:
the transmission occurs via ModBus.

17. A coriolis flow measuring device comprising:
an evaluation unit, wherein:
that at least one data set of number pairs (D), in each case, of a meter factor (C) and an associated Reynolds number (H), is stored in said evaluation unit; and
said evaluation unit is equipped to correct an uncorrected flow velocity and/or an uncorrected flow (E) by ascertaining the Reynolds number and by associating the meter factor (C) of a number pair (D) of the data set.

18. The coriolis flow measuring device as claimed in claim 17, wherein:
additionally one or more correction factors and/or one or more correction algorithms are stored in said evaluation unit; and
said evaluation unit is equipped to determine a meter factor by application of one of the correction factors and/or one of the correction algorithms for a Reynolds number ascertained for the measuring point when the Reynolds number ascertained at the measuring point does not correspond to a Reynolds number (H), which is stored as number pair (D) with a meter factor (C).
